(19) United States
(12) Patent Application Publication
(10) Pub. No.: US 2019/0310735 A1
(43) Pub. Date: Oct. 10, 2019

(54) METHOD FOR CORRECTING TOUCH POSITION OF STYLUS

(71) Applicant: ADONIT CO., LTD, Taipei City (TW)

(72) Inventors: Yueh-Hua LI, Taipei City (TW); Yu-Ting LO, Taipei City (TW)

(21) Appl. No.: 15/945,089

(22) Filed: Apr. 4, 2018

(51) Int. Cl. G06F 3/041; G06F 3/0354

(52) U.S. Cl. CPC G06F 3/0418; G06F 3/03545

(57) ABSTRACT

The present disclosure provides a method for correcting touch position to a tip of a stylus on a touch sensitive electronic device; the method is adapted to perform an actual touch point compensation of the tip of the styles including a first electrode and a second electrode separated from each other. The method includes: defining a distance coefficient by the distance between the first and the second electrodes; defining a first position by the projection of the first electrode on the touch sensitive electronic device; defining a second position by the projection of the second electrode on the touch sensitive electronic device; and performing the actual touch point compensation in accordance with the distance coefficient and the first and second positions.

### BACKGROUND

### Technical Field

The present disclosure relates to a touch method and, more particularly, to a method for correcting touch position of stylus.

### Description of Related Art

An electronic device can integrate a touch sensor into a display to facilitate a user's interaction with elements shown on the display. When the user touches the display with one or more fingers, the touch sensor provides the location of each touch to the electronic device which, in turn, can cause elements shown on the display (such as icons, buttons, keys, toolbars, menus, pictures, sprites, applications, documents, canvases, maps, and so on) to change.

A common touch input method includes touching a touch panel with a finger or a stylus; wherein, the operating principle of the stylus is to sense the capacitance between the touch pen and the touch panel. Determine the touch position of the stylus.

However, an actual touch point shifting problem is usually occurred when the angle between the stylus and the touch panel smaller than 90 degrees.

### SUMMARY

According to one aspect of the present disclosure, a method for correcting touch position to a tip of a stylus on a touch sensitive electronic device is adapted to perform an actual touch point compensation of the tip of the styles having a first electrode and a second electrode separated from each other; the method including: defining a distance coefficient by a distance between the first electrode and the second electrode; defining a first position by the projection of the first electrode on the touch sensitive electronic device; defining a second position by the projection of the second electrode on the touch sensitive electronic device; and performing the actual touch point compensation in accordance with the first position, the second position, and the distance coefficient.

### BRIEF DESCRIPTION OF DRAWING

The present disclosure can be more fully understood by reading the following detailed description of the embodiment, with reference made to the accompanying drawings as follows:

FIG. 1A depicts a perspective view of a user input system in accordance with an embodiment of the present disclosure;

FIG. 1B depicts a top view of the user input system in accordance with the embodiment of the present disclosure;

FIG. 2 depicts a partial cross-sectional view of a stylus in accordance with the embodiment of the present disclosure;

FIG. 3 depicts a side view of the user input system in accordance with the embodiment of the present disclosure; and

FIG. 4 depicts an enlarged view of the user input system of FIG. 3.

### DETAILED DESCRIPTION

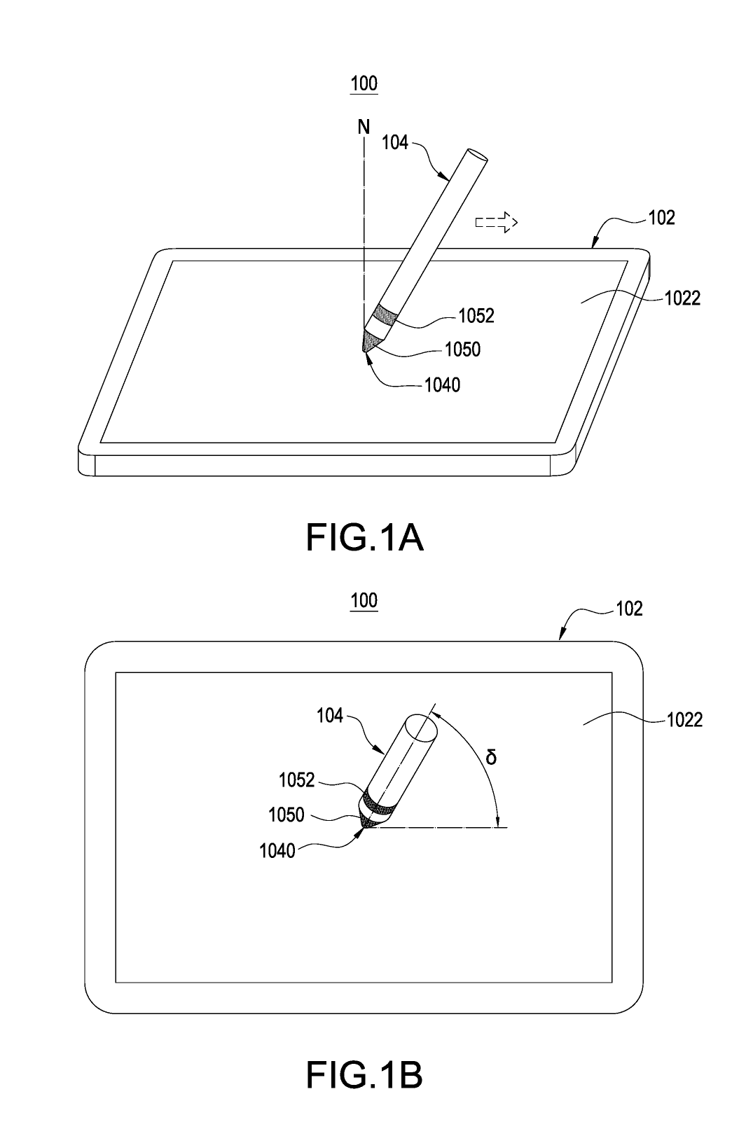

FIG. 1A depicts a perspective view of a user input system in accordance with an embodiment of the present disclosure, and FIG. 1B depicts a top view of the user input system in accordance with the embodiment of the present disclosure. In FIG. 1A and FIG. 1B, the user input system 100 includes a touch sensitive electronic device 102 and a stylus 104; a user slides a tip 1040 of the stylus 104 across an input surface 1022 of the touch sensitive electronic device 102 to interact with a user interface presented or rendered on a display of the touch sensitive electronic device 102.

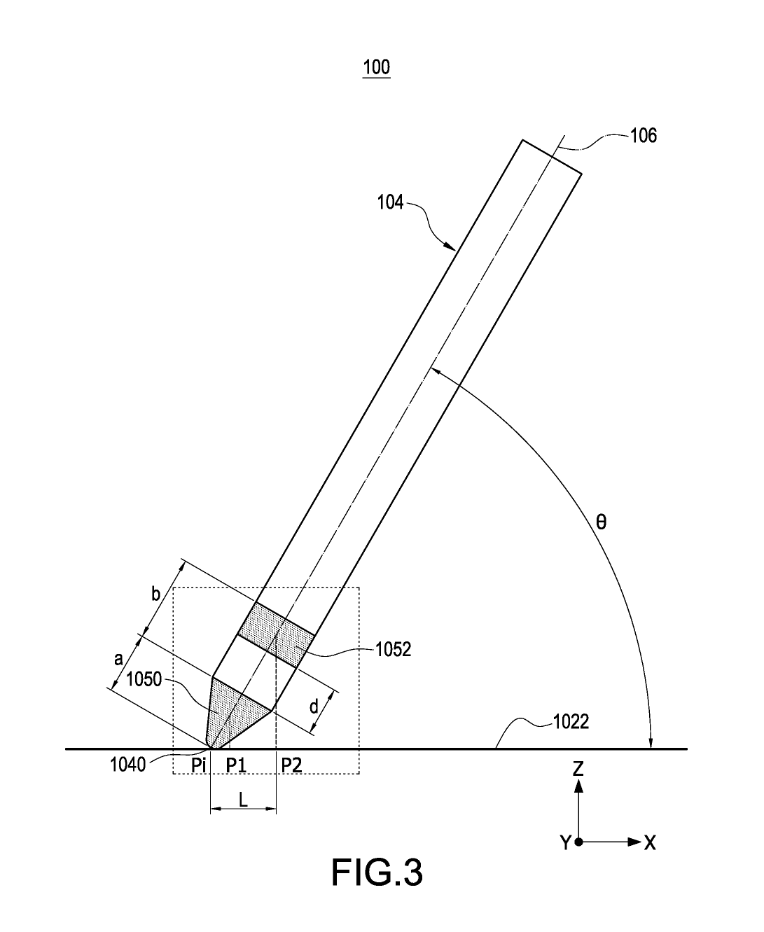

More specifically, the user manipulates the position (and orientation) of the stylus 104 relative to the input surface 1022 of the touch sensitive electronic device 102 in order to convey information to the touch sensitive electronic device 102. The touch sensitive electronic device 102 may be configured to perform or coordinate multiple operations such as, but not limited to, locating the stylus 104, compensating (or called “correcting”) the actual position (i.e., an actual touch point Pi shown in FIG. 3) of the tip 1040 of the stylus 104, estimating the angular position of the stylus 104, and so on. The touch sensitive electronic device 102 is presented in FIG. 1A and FIG. 1B as a tablet computing device as an example only; other electronic device are envisioned. For example, the touch sensitive electronic device of the user input system 100 can be implemented as a mobile phone, a media player, a personal computer, and the like.

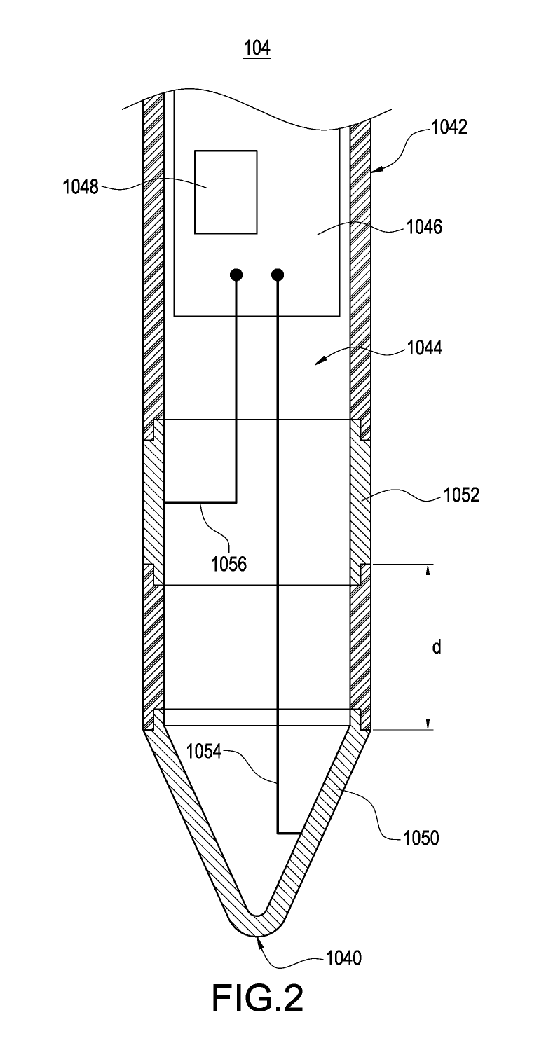

FIG. 2 depicts a partial cross-sectional view of a stylus in accordance with the embodiment of the present disclosure. In FIG. 2, the stylus 104 includes a barrel 1042; the barrel 1042 can be formed from plastics, ceramics, glass, wood, leather, synthetic materials, or any other insulating material or combination of materials. The barrel 1042 can exhibit a variable and a constant cross-section; the barrel 1042 may have a circular cross-section or a polygonal cross-section (such as a triangular cross-section, a pentagonal cross-section, and so on). The barrel 1042 is formed with an accommodating space 1044 for housing a circuit board 1046; the circuit board 1046 is provided for carrying a driving circuit 1048 configured to control multiple operations of the stylus 104.

The stylus 104 further includes a first electrode 1050 and a second electrode 1052, which are made of metal conductor(s). The first electrode 1050 attached to an end of the barrel 1042 decreases in diameter, linearly or non-linearly, away the barrel 1042 to form the tip 1040 configured to contact the input surface 1022 of the touch sensitive electronic device 102. The second electrode 1052 arranged on the barrel 1042 is displaced by a predetermined distance d from the first electrode 1050, so that the second electrode 102 is electrically insulation from the first electrode 1050. The first electrode 1050 is electrically connected to the circuit board 1046 via a wire 1054, and the second electrode 1052 is electrically connected to the circuit board 1046 via another wire 1056. The driving circuit 1048 is configured to provide a first signal to the first electrode 1050 and a second signal to the second electrode 1052. In should be noted that the first signal has a frequency and/or amplitude that is different from a frequency and/or amplitude of the second signal, so that the first and second signals emitted from different electrodes can be distinguish from one another.

FIG. 3 depicts a side view of the user input system in accordance with the embodiment of the present disclosure. In the present disclosure, the actual touch point Pi compensation can typically be performed during the stylus 104 is not perpendicularly touching or hovering over the touch sensitive electronic device 102 (i.e., during an angle θ between a longitudinal axis 106 of the stylus 104 and the input surface 1022 is not equal to 90 degrees). More specifically, the touch sensitive electronic device 102 can determine the actual touch point Pi on the input surface 1022 by calculating a distance coefficient, a first point P1, and a second point P2; the distance coefficient is pre-defined and/or known coefficient between the first electrode 1050 and the second electrode 1052, the first point P1 and the second point P2 are determined by projected positions of the first electrode 1050 and the second electrode 1052 on the touch sensitive electronic device 102, respectively.

In the present disclosure, the first point P1 represents projected position of the geometry center or the center of gravity of the first electrode 1050 on the touch sensitive electronic device 102, and the second point P2 represents projected position of the geometry center or the center of gravity of the second electrode 1052 on the touch sensitive electronic device 102. In detail, the geometry center or the center of gravity of the first electrode 1050 may be the position for outputting the first signal to the touch sensitive electronic device 102 for generating a capacitive coupling effect on the touch sensitive electronic device 102 and inducing an induced capacitance with respect to the input surface 1022 of the touch sensitive electronic device 102; similarly, the geometry center or the center of gravity of the center of the second electrode 1052 may be the position for outputting the second signal to the touch sensitive electronic device 102 for generating another capacitive coupling effect on the touch sensitive electronic device 102 and inducing another induced capacitance with respect to the input surface 1022 of the touch sensitive electronic device 102. The touch sensitive electronic device 102 may determine coordinates of the first point P1 and the second point P2 by the induced capacitances mentioned above. The coordinates of the first point P1 and the second point P2 can be used to correct the actual touch point Pi of the tip 1040 of the stylus 104.

Under an ideal state, the first point P1, the second point P2, and the actual touch point Pi are arranged in a line. In addition, the length of the first electrode 1050, the length of the second electrode 1052, and the predetermined distance d are constants, respectively. As a result, the touch sensitive electronic device 102 configured to determine coordinates of the first point P1 and the second point P2 is used to calculate the coordinate of the first point P1, the coordinate of the second point P2, and the distance coefficient to obtain (the coordinate of) the actual touch point Pi.

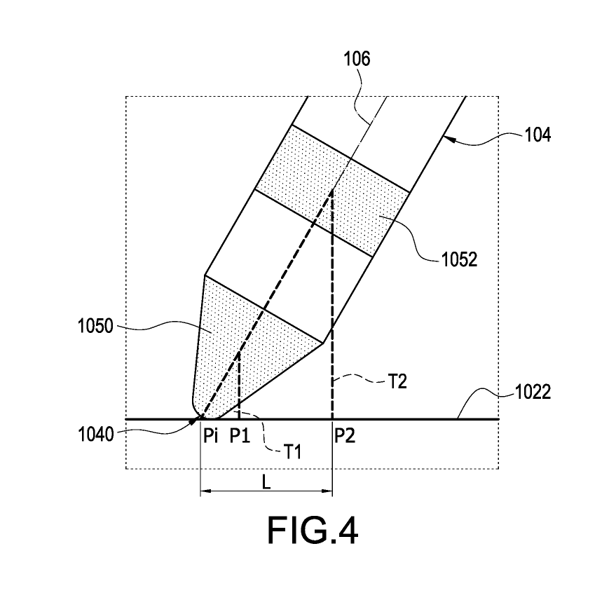

The touch sensitive electronic device 102 may determine the coordinates of the first point P1 and the second point P2 as (X1, Y1) and (X2, Y2), respectively. As shown in FIG. 3 and FIG. 4, the input surface 1022, the longitudinal axis 106, and an extended line of the first point P1 along the Z axis collectively constitute a first triangle T1 during the angle θ between the longitudinal axis 106 of the stylus 104 and the input surface 1022 is not 0 degree; similarly, the input surface 1022, the longitudinal axis 106, and an extended line of the second point P2 along the Z axis collectively constitute a second triangle T2. The first triangle T1 and the second triangle T2 are similar triangles. As a result, when the length of the first electrode 1050 is a, the sum of the length of the second electrode 1052 and the predetermined distance is b, a coordinate of the actual touch point is (Xi, Yi), and the following conditions are satisfied:

Xi=X1+k(X1−X2); and

Yi=Y1+k(Y1−Y2),

wherein k (distance coefficient)=a/b.

For example, when the coordinate of the first point P1 is (0, 0), the coordinate of the second point P2 is (5, 0), the length of the first electrode 1050 is one-unit-length, and the sum of the length of the second electrode 1052 and the predetermined distance is two-unit-length, the coordinate of the actual touch point Pi is (−2.5, 0).

In order to shift the touch sensitive electronic device 102 unable to position the first point P1 correctly due to hand trebling of the user, a weighted value f may be provided for producing a stabile first point P1.

In detail, when an instant first point is P1(n−1), a next first point is P1n′, the weighted value is f, the following condition is satisfied:

P1=(1−f)*P1(n−1)+f′*P1n′,

Wherein f<1, and f′<f∘

Similarly, when an instant second point is P2(n−1), a next second point is P2n′, the weighted value is f, the following condition is satisfied:

P2=(1−f)*P2(n−1)+f′*P2n′,

Wherein f<1, and f′<f∘

Relative positioning between the actual touch point Pi and the second point P2 is used to determine a tilt of the stylus 104 with respect to touch sensitive electronic device 102. In general, the angle θ is great when the longitudinal axis 106 is the stylus 104 closes to the normal N of the touch sensitive electronic device 102 (as shown in FIG. 1); on the contrary, the longitudinal axis 106 away from the normal N while the angle θ is small. In addition, the sum (b) of the length of the second electrode 1052 and the predetermined distance is a constant. Thus, the angle θ may be obtained by calculating a distance L between the actual touch point Pi and the second point P2. The angle θ is between 0 to 60 degrees.

More specifically, when the coordinate of the second point is (X2, Y2), the coordinate of the actual touch point Pi is (Xi, Yi), the distance L is determined by:

L=|\vec{P1P2}|=\sqrt{(X2−Xi)²+(Y2−Yi)²}

A look-up-table relating the distance L to the angle θ with respect to the normal N of the touch sensitive electronic device 102 may be pre-stored in memory associated with the touch sensitive electronic device 102 and is used to define tilt of stylus 140.

Furthermore, the present disclosure may further determine the orientation angle δ of the stylus 104 with respect to an axis of the touch sensitive electronic device 102; in detail, when the coordinate of the second point is (X2, Y2), the coordinate of the actual touch point Pi is (Xi, Yi), the distance L is determined by:

δ=tan 2⁻¹(y, x), wherein x=(X2−Xi), y=(Y2−Yi)∘

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the disclosure as defined in the appended claims.

What is claimed is:

1. A method for correcting touch position to a tip of a stylus on a touch sensitive electronic device adapted to perform an actual touch point compensation of the tip of the styles comprising a first electrode and a second electrode separated from each other, the method comprising:
defining a distance coefficient by a distance between the first electrode and the second electrode;
defining a first position by the projection of the first electrode on the touch sensitive electronic device;
defining a second position by the projection of the second electrode on the touch sensitive electronic device; and
performing the actual touch point compensation in accordance with the first position, the second position, and the distance coefficient.

2. The method of claim 1, wherein a predetermine length is existed between the first electrode and the second electrode, and the distance coefficient is a ratio of the length of the first electrode and a sum of the length of the second electrode and the predetermined distance

3. The method of claim 2, wherein the ratio of the length of the first electrode and the a sum of the length of the second electrode and the predetermined distance is equal to the distance between the actual touch point and the first point and the distance between the first point and the second point.

4. The method of claim 2, wherein when the length of the first electrode is a, a sum of the length of the second electrode and the predetermined distance is b, a coordinate of the first position is (X1, Y1), a coordinate of the second position is (X2, Y2), a coordinate of the actual touch point is (Xi, Yi), and the following conditions are satisfied:
Xi=X1+k(X1−X2); and
Yi=Y1+k(Y1−Y2), wherein k=a/b.

5. The method of claim 1, wherein the first point represents projected position of the geometry center or the center of gravity of the first electrode on the touch sensitive electronic device, and the second point represents projected position of the geometry center or the center of gravity of the first electrode on the touch sensitive electronic device

6. The method of claim 5, wherein the geometry center or the center of gravity of the first electrode is the position for outputting a first signal to the touch sensitive electronic device for generating a capacitive coupling effect on the touch sensitive electronic device and inducing an induced capacitance with respect to the touch sensitive electronic device, and the geometry center or the center of gravity of the center of the second electrode is the position for outputting a second signal to the touch sensitive electronic device for generating another capacitive coupling effect with respect to the touch sensitive electronic device and inducing another induced capacitance on the touch sensitive electronic device 102.

7. The method of claim 6, wherein a frequency or amplitude of the first signal is different from that a frequency or amplitude of the second signal.

8. The method of claim 1, further comprising:
determining the first point in accordance with a position of instant first point, a position of next first point, and a weighted value; and
determining the second point in accordance with a position of instant first point, a position of next first point, and a weighted value.

9. The method of claim 1, further comprising:
determining an angle of a longitudinal axis of the stylus respect to the touch sensitive electronic device in accordance with the actual touch point and the second point.

10. The method of claim 1, further comprising:
determining an orientation angle of the stylus in accordance with the actual touch point and the second point.
